(19) United States
(12) Patent Application Publication
(10) Pub. No.: US 2016/0310866 A1
(43) Pub. Date: Oct. 27, 2016

(54) CHILDREN'S PLAY KITCHEN

(71) Applicants: Anil NAPHRAY, Surrey (GB); David WOODMAN, Lincolshire (GB); Rebecca SNAPE, Lincolshire (GB); PLUM PRODUCTS HOLDINGS PTY LTD., Neutral Bay NSW (AU)

(72) Inventors: Rebecca SNAPE, Ingham (GB); David WOODMAN, Ingham (GB); Anil NAPHRAY, Woking (GB)

(73) Assignee: PLUM PRODUCTS HOLDINGS PTY LTD., Neutral Bay, New South Wales (AU)

(21) Appl. No.: 15/103,380

(22) PCT Filed: Dec. 9, 2014
(86) PCT No.: PCT/GB2014/000510

§ 371 Date: Jun. 10, 2016

(30) Foreign Application Priority Data
Dec. 10, 2013 (GB) 1321799.7
Aug. 14, 2014 (GB) 1414420.8

(51) Int. Cl. A63H 33/30; F16M 13/02

(52) U.S. Cl. CPC A63H 33/30; A63H 33/3055; A63H 33/3061; F16M 13/02; A63H 2200/00

(57) ABSTRACT

A children's play kitchen includes a representation of a piece of kitchen equipment. The representation includes a front panel provided with a holder. The holder is adapted to hold a piece of electronic equipment selected from tablet computers, smart phones and other programmable devices having a generally flat screen on a front side thereof, the piece of electronic equipment contains preloaded software such that when a user activates the software the screen displays visual content making it appear as if the kitchen equipment were in use. The software may be provided as an app.

### BACKGROUND

This disclosure relates to children's play kitchens.

Play kitchens are well known and have been seen as a staple children's toy for many years. Play kitchens are normally designed to include a representation of one or more pieces of kitchen equipment so that a child may play at using the real thing This equipment commonly includes ovens, microwave ovens, washing machines and/or a sink. Even with the addition of lights or even sound effects, prior play kitchens have provided only static displays. As will become apparent from the detailed description herein below of preferred embodiments, our play kitchens provide a true visual illusion of a piece of kitchen equipment, for example the oven, microwave oven or washing machine, actually working as they would in a real kitchen, thereby greatly enhancing the lifelikeness of the kitchen and the child's experience.

DVDs have been played on a strategically placed television screen placed in a hearth to create the illusion of a log fire or on a stand or shelf as an aquarium. However, to the best of Applicant's knowledge such an illusion has never previously been applied to create the effect of working kitchen equipment in a play kitchen. In any event, given that play kitchens are not provided with functioning TVs and DVD players, such an illusion could not readily be achieved heretofore.

### SUMMARY OF THE DISCLOSURE

This disclosure arises from Applicant's work in seeking to provide a more realistic play kitchen to better entertain children.

According to a first aspect of this disclosure, there is provided a children's play kitchen, the play kitchen including a representation of a piece of kitchen equipment, the representation including a front panel provided with a holder, the holder being adapted to hold a piece of electronic equipment selected from tablet computers, smart phones and other programmable devices having a generally flat screen on a front side thereof, the piece of electronic equipment having a screen and containing preloaded software such that when a user activates the software the screen displays visual content making it appear as if the kitchen equipment were in use.

Preferred embodiments may have one or more of the following features: The front panel is provided with an aperture and the holder is provided behind the front panel, such that when the piece of electronic equipment is held in the holder the screen is visible through the aperture. The holder includes a fixed platform and at least one movable clamp adapted to operate in conjunction with the fixed platform. The holder includes at least two clamps designed to hold the electronic equipment between them. The play kitchen comprises two clamps, each including an element adapted to engage an edge of the piece of electronic equipment, the said element including two surfaces orthogonal to each other, one said surface being adapted to engage a vertical edge of a said piece of electronic equipment to hold it vertically with its screen facing forwardly of the kitchen equipment, and the other said surface being adapted to prevent the said piece of electronic equipment from falling forwardly from a vertical position. A rear panel is positioned behind the front panel, the rear panel mounting said at least two clamps, the said clamps being slidable along at least one slot and each being fixable in position along the or a said slot, each clamp comprising a bracket and a shank extending through the associated slot and mounting a tightening knob, whereby the separation between the respective brackets may be adjusted to hold a said piece of electronic equipment between them with each bracket engaging a respective edge of the electronic equipment, each bracket having a hooked portion adapted to hook around an edge of the electronic equipment on to a front surface thereof, whereby tightening of the knob draws the hooked portion of the bracket into engagement with the said front surface to hold the electronic equipment against the said rear panel. Each bracket has at least two protrusions on its rear face, and each slot is associated with two guide slots or grooves in the rear panel running parallel to and on either side of the slot and adapted to receive the protrusions to assist in maintaining a bracket in a desired orientation during movement and when held in position by tightening the knob. The position of the or each clamp may be selected by a user; and wherein the or each said clamp includes at least one tightening knob adapted when tightened to hold the clamp in position. The or each knob comprises two sections, namely an outer section and an inner, biased apart by a spring, the inner section being provided with a series of one of teeth and notches designed to interfit with a corresponding series of the other of notches and teeth provided on the outer section, so that the knob may be tightened or loosened only when the inner and outer sections are engaged to interfit teeth and notches by a user against the bias of the spring. The inner and outer sections are adapted to engage by compressing the spring, the stiffness of the spring being selected so that an adult can readily compress the spring, but young children would find this more difficult, thereby deterring a child from removing the electronic device from the holder by playing with the knobs, since loosening a said knob to allow removal would require the knob to be pushed and turned simultaneously.

In an alternative arrangement, the holder comprises a pocket into which the piece of electronic equipment may be inserted from above. In a further alternative, the holder is associated with at least one clamp adapted to hold the piece of electronic equipment against a front surface of the front panel, wherein the or each said clamp is hidden behind a decorative element.

The piece of kitchen equipment may be selected from, but is not limited to, an oven, a microwave, a washing machine, a tumble drier, a coffee machine, a blender, a mixer and a fridge-freezer.

At least one speaker may be associated with the said piece of electronic equipment so that when the visual content is displayed on the screen of the electronic equipment corresponding audible content accompanies the visual content.

The software may be interactive such that the content varies depending on options selected by a user.

According to a second aspect of this disclosure, there is provided in combination: a children's play kitchen and an electronic application for a tablet computer or smart phone; the play kitchen including a representation of a piece of kitchen equipment, the representation including a front panel provided with a holder, the holder being adapted to hold a piece of electronic equipment selected from tablet computers and smart phones; and the electronic application being programmed to display visual content on the screen of the electronic equipment making it appear as if the kitchen equipment were in use.

### BRIEF DESCRIPTION OF THE DRAWINGS

Preferred embodiments are described hereinbelow by way of example only with reference to the accompanying drawings, in which:

FIG. 1 is a perspective view of a portion of a play kitchen depicting a representation of a microwave oven with the door open;

FIG. 2 is a perspective view of the portion of the play kitchen depicted in FIG. 1 with the door of the microwave oven closed;

FIG. 3 is a front perspective view of a front panel of a play kitchen and associated clamps;

FIG. 4 is a rear perspective view of the front panel of the play kitchen and associated clamps of FIG. 3;

FIG. 5 is a top plan view of the front panel of the play kitchen and associated clamps of FIGS. 3 and 4;

FIG. 6 is a front plan view of the front panel of the play kitchen and associated clamps of FIGS. 3 to 5;

FIG. 7 is a side plan view of the front panel of the play kitchen and associated clamps of FIGS. 3 to 6;

FIG. 8 is a sectional view of the front panel of the play kitchen and associated clamps of FIGS. 3 to 7, as seen along the line VIII-VIII in FIG. 6;

FIG. 9 is a front perspective view of the front panel of the play kitchen and associated clamps of FIGS. 3 to 8 with a tablet computer positioned between the clamps;

FIG. 10 is a front perspective view of the front panel of the play kitchen and associated clamps of FIGS. 3 to 9 with a smart phone positioned between the clamps;

FIG. 11 is a front perspective view of the front panel of the play kitchen FIGS. 3 to 10 with the clamps removed;

FIG. 12 is a rear perspective view of the front panel of the play kitchen FIGS. 3 to 11 with the clamps removed;

FIG. 13 is a perspective view of the clamp and knobs of FIGS. 3 to 10;

FIG. 14 is a front plan view of the knob of FIGS. 3 to 10 and 13 on an enlarged scale;

FIG. 15 is a side plan view of the knob of FIGS. 3 to 10 and 13 to 14;

FIG. 16 is a front perspective view of a front panel of a play kitchen and alternative associated clamps;

FIG. 17 is a rear perspective view of the front panel of the play kitchen and associated clamps of FIG. 16;

FIG. 18 is a front perspective view of a front panel of a play kitchen and further alternative associated clamps;

FIG. 19 is a front perspective view of a play kitchen provided with a further alternative pair of clamps in a front panel and a smart phone located between the clamps;

FIG. 20 is a front perspective view of the smart phone located between the pair of clamps in the front panel of FIG. 19;

FIG. 21 is a rear perspective view of the front panel of FIGS. 19 and 20 and a pair of knobs associated with clamps;

FIG. 22 is a front perspective view of the play kitchen of FIG. 19 and a tablet computer located between the clamps;

FIG. 23 is a front plan view of the front panel and pair of clamps of FIGS. 19 to 21 and a tablet computer located between the clamps;

FIG. 24 is a side plan view of the front panel and pair of clamps of FIGS. 19 to 21 and 23 and a tablet computer located between the clamps;

FIG. 25 is a front perspective view of the clamp of FIGS. 19 to 20 and 22 to 24;

FIG. 26 is a rear perspective view of the clamps of FIGS. 19 to 20 and 22 to 25;

FIG. 27 is a flow diagram showing how the software may be installed and interacted with;

FIG. 28 is a perspective rear view of an alternative door of a play kitchen showing slots in which associated clamps may be positioned;

FIG. 29 is a front perspective view of a rear panel of the door of FIG. 28 and associated clamps;

FIG. 30 is a rear perspective view of the rear panel of the door of FIG. 28 and associated clamps;

FIG. 31 is a rear perspective view of a clamp;

FIG. 32 is a side perspective view of a bracket of the clamp of FIG. 31, showing a threaded metal insert;

FIG. 33 is a side perspective view of a first embodiment of a knob with a threaded shank used in the clamp of FIGS. 31 and 32;

FIG. 34 is a cross-sectional view of the knob of FIG. 33;

FIG. 35 is a cross-sectional view of a so-called “child-proof” knob serving as an alternative to the knob of FIGS. 33 and 34;

FIG. 36 is a cross-sectional view of the knob of FIG. 35 with an internal spring compressed;

FIG. 37 is a view of an inner section of the knob of FIGS. 35 and 36 showing teeth arranged to engage with notches in an outer section of the knob of FIGS. 35 and 36 and;

FIG. 38 is a view of an outer section of the knob of FIGS. 35 and 36 showing notches arranged to engage with the teeth of the knob inner of FIG. 37

### DESCRIPTION OF PREFERRED EMBODIMENTS

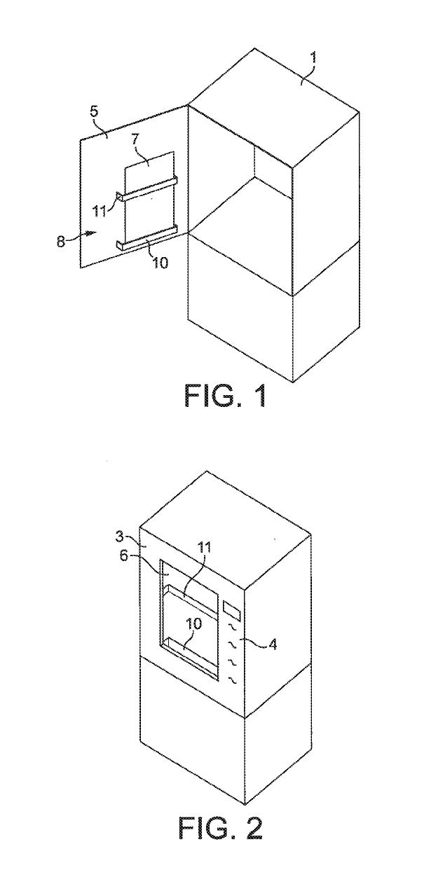

Referring first to FIGS. 1 and 2 a portion 1 of a children's play kitchen 2 is shown. The portion 1 illustrated includes a front panel 3 which depicts the front of a microwave oven 4. Due to the front panel 3 being hinged to the rest of the children's play kitchen 2 the microwave oven 4 appears to have an opening door 5. An aperture 6 provided in the door 5 depicts the window 7 of the microwave 4. A holder 8 adapted to hold a tablet computer 9 (not shown in FIGS. 1 and 2) is provided behind the door 5. The holder 8 comprises a pocket 10 and a support band 11. When the door 5 is open a tablet computer 9 may be lowered into the holder 8 by a user. The door 5 may then be closed with the tablet computer 9 held in position relative to the door 5.

The tablet computer 9 will have been preloaded with an electronic application, the electronic application being designed to display visual content on the screen of the tablet computer 9, when prompted to do so by a user, making it appear as if the microwave oven 4 were in use. In this instance, suitable visual content may be some food rotating in a microwave oven 4. Audible content accompanying the visual content may also be played through speakers of the tablet computer 9 or accessory speakers in the kitchen equipment.

While FIGS. 1 and 2 show decorative material on the panel 3 depicting a microwave oven 4, this is not essential. It will be readily understood that all the necessary decoration could be displayed on the screen of the electronic equipment. This arrangement has the added benefit of allowing one panel at any time to act as a selected one of a multiple different pieces of equipment depending on the selection of the user.

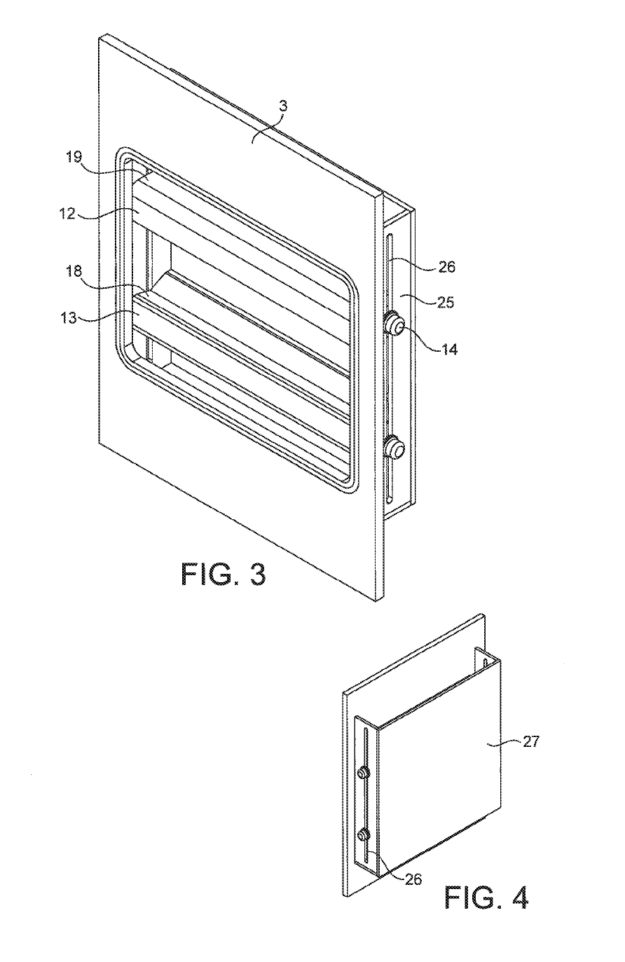

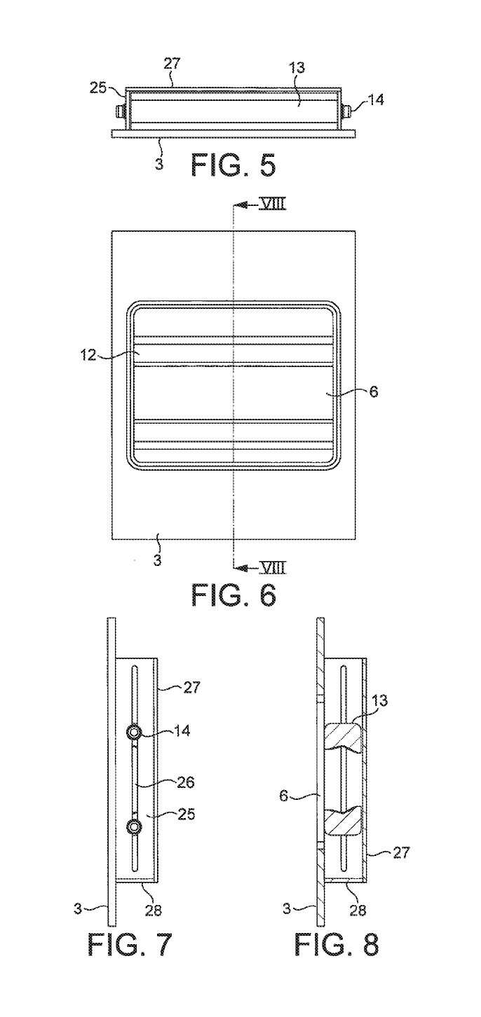

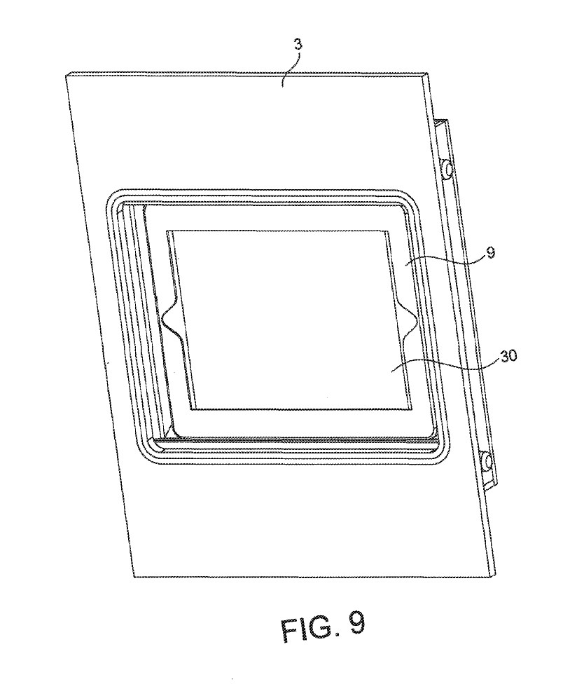

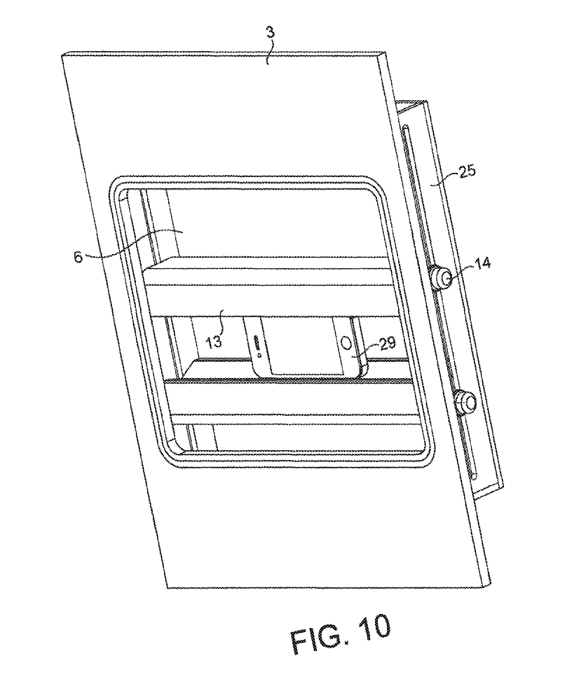

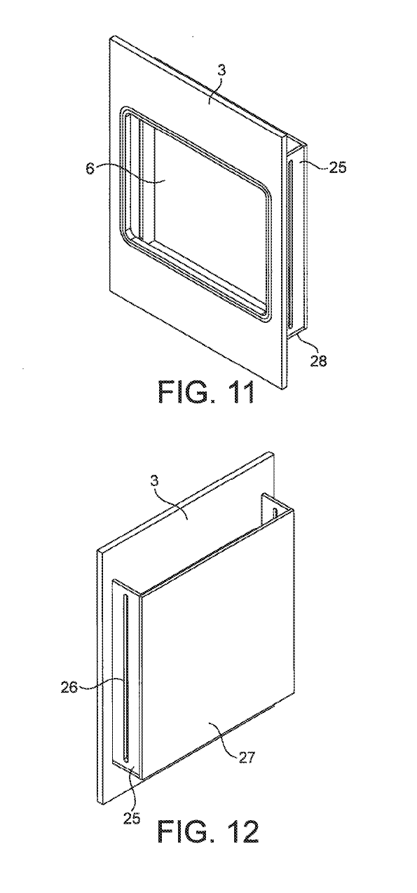

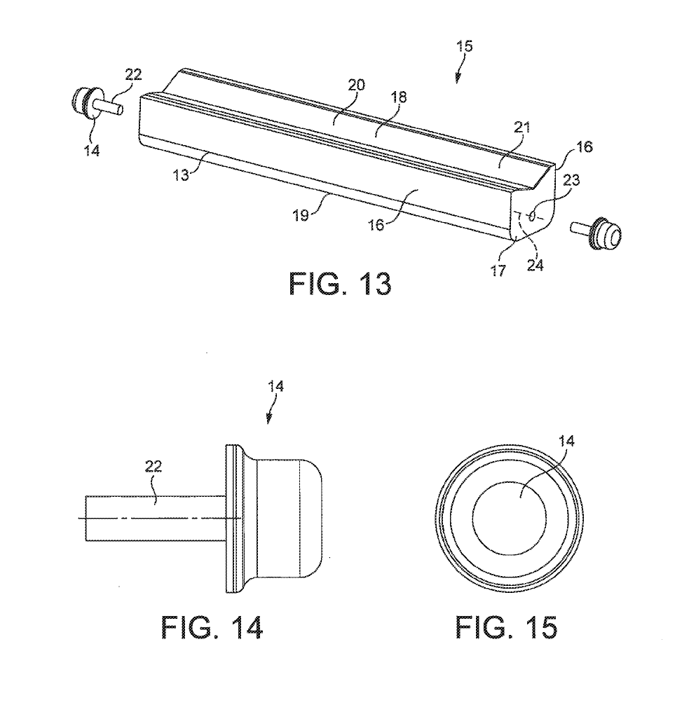

Alternatively the holder 8 could comprise a pair of clamps 12. One possible arrangement is shown in FIGS. 3 to 15 and discussed below. A front panel 3 which forms part of a children's play kitchen 2 contains an aperture 6. Located behind the panel is a pair of clamps 12 each clamp comprising an elongate member 13 and a pair of knobs 14 associated with that member 13. It will be appreciated that the elongate members 13 and knobs 14 could be made from a variety of materials. However, we have had success making the elongate members 13 primarily from wood and the knobs 14 from injected plastics.

Each elongate member 13 is predominantly cuboid shape 15 with two opposing sides 16, two opposing ends 17, a front 18 and a back 19. The front 18 will come into contact with the electronic equipment and is opposite the back 19. To prevent damage to the electronic equipment the front 18 is provided with padding 20. A range of materials may be used but we have had good results with felt glued to the surface of the elongate member 13. To hold the electronic equipment securely the front 18 is not a single flat surface but instead is concave. In the accompanying drawings this is shown as two flat surfaces 21 which meet in the centre of the front 18. However, the elongate member 13 could equally be provided with a front 18 which was curved.

Each knob 14 is provided with a threaded bolt 22. The threaded bolt 22 is capable of screwing into a corresponding threaded hole 23 which is provided on either end 17 of the elongate member 13. To prevent excessive wear we have found that a metal insert 24 threaded to correspond to the bolt 22 may be embedded in either side of the elongate member 13. Two side walls 25 are provided behind the front panel 3 on either side of the aperture 6. The side walls 25 are provided with channels 26 such that a pair of elongate members 13 may be positioned between the side walls 25 with their fronts 18 facing inwards, each elongate member 13 being secured in place due to a threaded bolt 22 passing through each channel 26 and screwing into the threaded hole 23 until a knob 14 acts on each wall 25 locking the elongate member 13 in place. When the user wishes to move the clamps 12, the knobs 14 may be loosened and the clamps 12 may be moved up and down.

In the Figures the side walls 25 are shown interconnected by a rear wall 27 and base 28. However, these are not always necessary.

A piece of electronic equipment such as a tablet computer 9 or smart phone 29 may be inserted through the aperture 5 and, by adjusting the position of the clamps 12, may be held securely in place. It will be readily understood that if the interconnecting rear wall 27 were not provided then the electronic equipment could also be inserted from behind. Alternatively the piece of electronic equipment could be inserted from above if the user removed the upper clamp 12 and replaced it once the electronic equipment was in the desired position.

As before, the electronic equipment will have been preloaded with an electronic application, the electronic application being designed to display visual content on the screen 30 of the electronic equipment, when prompted to do so by a user, making it appear as if a kitchen appliance were in use. Depending on the decoration of the front panel 3, a suitable video could be, for example, some food rotating in a microwave oven 4, clothes spinning in a washing machine or tumble drier, a chicken rotating on a rotisserie, or ice being crushed in an ice crusher of a fridge-freezer. Audible content accompanying the visual content may also be played through the speakers of the electronic equipment or accessory speakers coupled to the electronic equipment.

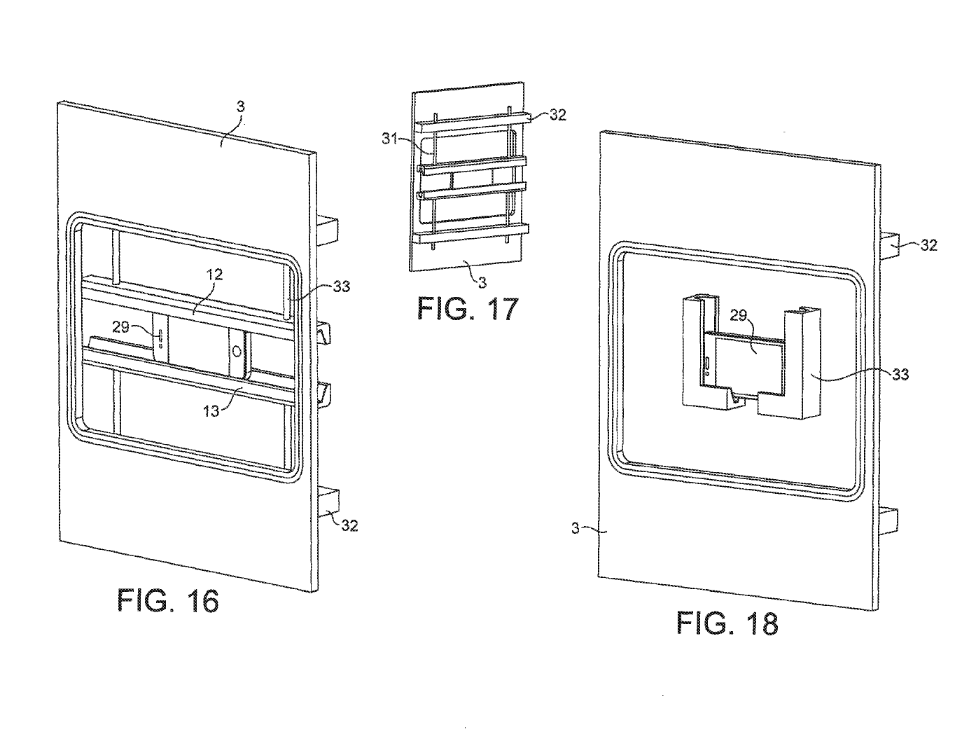

An alternative arrangement for a pair of clamps 12 is shown in FIGS. 16 and 17. The clamps 12 comprise two elongate members 13 which are similar to those previously described. Each elongate member is supported by two threaded rods 31 which extend through an associated ledge 32. The ledge 32 associated with the upper elongate member 13 is connected to the back of front panel 3 and is provided above the aperture 6, and the ledge 32 associated with the lower elongate member 13 is connected to the back of front panel 3 and is provided below the aperture 6. The rods 31 will be secured by tightening bolts, which are located on the threaded rods 31, either side of ledge 32.

Alternatively, a pair of clamps could comprise two L-shaped members 33 as shown in FIG. 18. While not shown, the position of these clamps could be controlled as previously described.

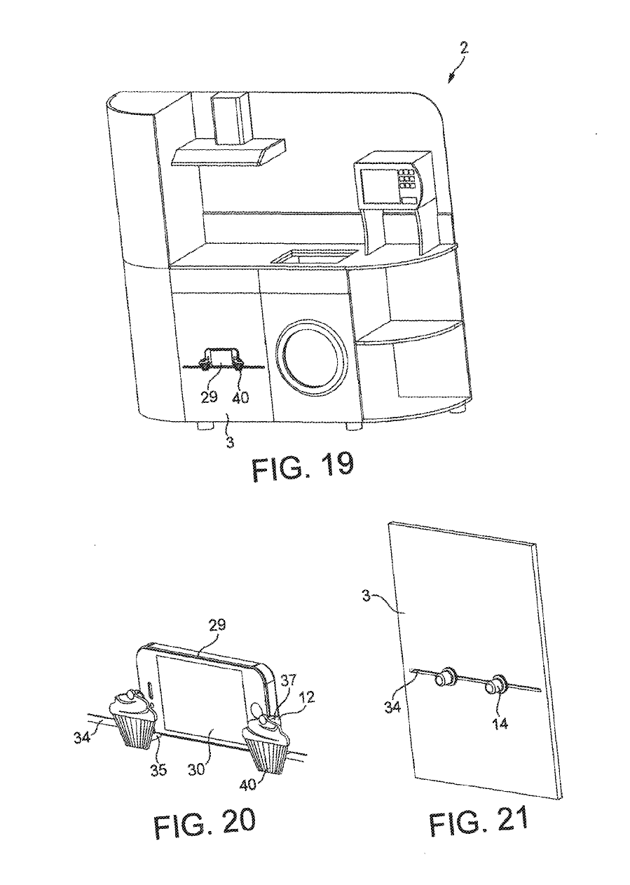

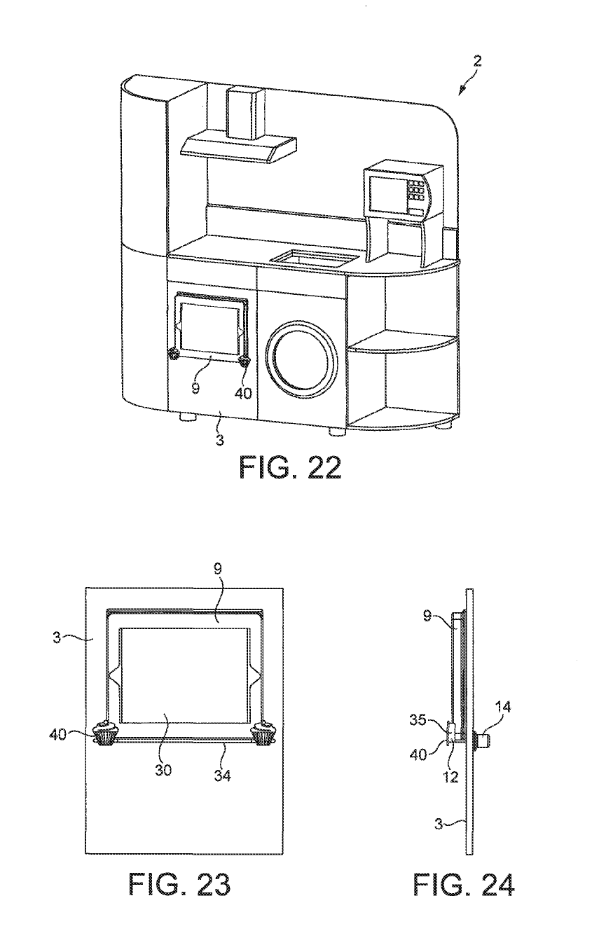

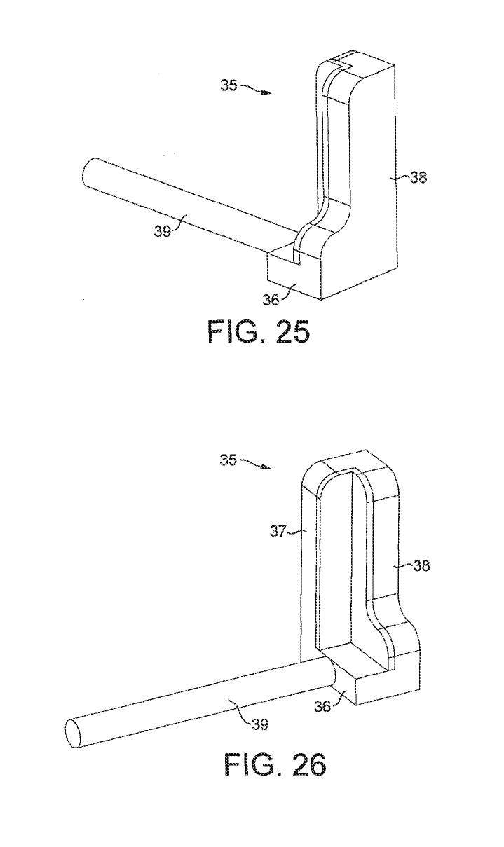

A further arrangement for supporting the electronic equipment is shown in FIGS. 19 to 24. A children's play kitchen 2 includes a front panel 3. The front panel 3 is provided with a channel 34. A pair of clamps 12 is provided. The clamps 12 consist of a pair of symmetrical members 35 which comprise a base 36 and a side 37 behind a front portion 38. The side 37 and front 38 define two surfaces orthogonal to each other. A threaded elongate member 39 extends from the base 36. The clamps 12 may hold a piece of electronic equipment in place when the elongate members 39 extend through the channel 34 and knobs 14 are screwed onto the elongate members. The electronic equipment may rest on the base 36 with a first surface of side 37 engaging an edge of the electronic equipment, preventing the electronic equipment from moving to either side when there are two clamps opposite each other, one being the mirror image of the other. A second surface of front 38 orthogonal to the first surface preventing the electronic equipment from toppling forward. The clamps may be hidden by a decorative element 40, here a cupcake, being stuck on the front 38.

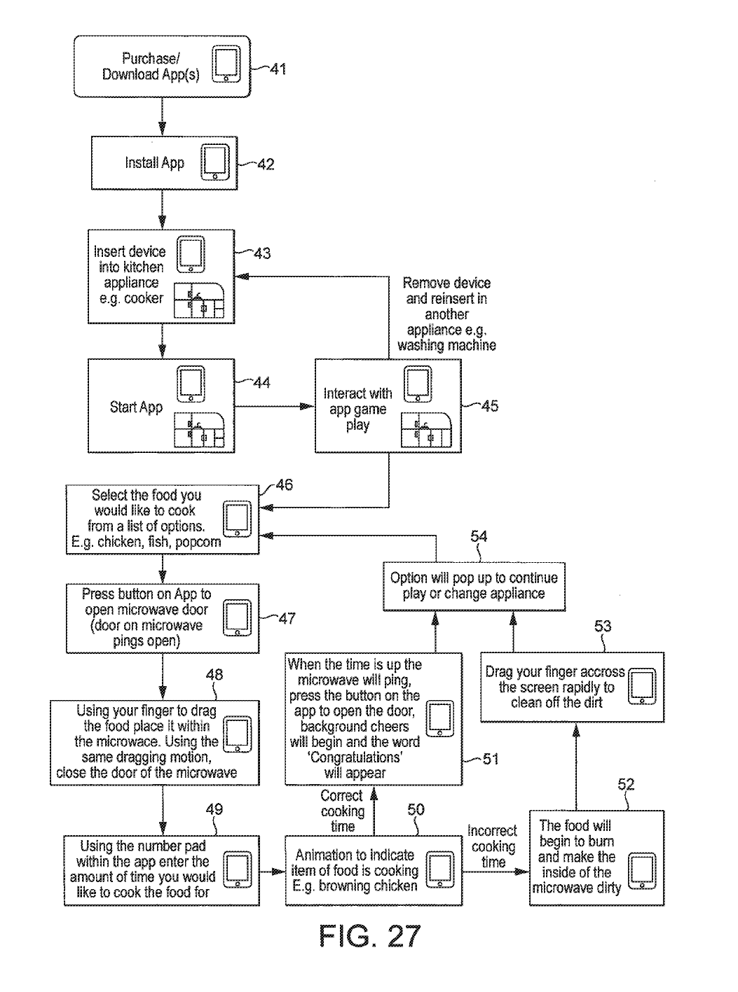

FIG. 27 shows how the software can be loaded onto the electronic equipment and how a user may interact with the software.

The software should first be downloaded onto the electronic device (Step 41). The software could either be downloaded from a specific applications store, such as the iTunes® Store or the Android® Marketplace, or it could be downloaded from a website. The software should then be installed onto the electronic device (Step 42). This may happen automatically once the download has completed.

The electronic device can then be inserted into the holder (Step 43), as explained previously, and the user can start the application running (Step 44). Once the application is running the user may interact with the application. In FIG. 27 the flow chart is set out as if the user had selected the kitchen appliance to be a microwave oven. However, it will be readily understood that a similar method of play could apply to other devices.

In this instance, a user can select the type of food they wish to cook (Step 46) by pressing an appropriate representation of a button on the microwave representation on the electronic device. Once the food is selected the user may press the correct button (Step 47) on the screen 30 to open the microwave oven door. By dragging their finger across the screen 30, the user may then place the food in the microwave oven and close the door (Step 48). At this point the user may use the number pad displayed on the screen 30 to select the time for which they wish the food to cook (Step 49).

The visual content will then indicate that the food is cooking (Step 50). This could be shown by a chicken browning, a cake rising or popcorn popping, as appropriate. The visual content may be accompanied by audible content playing the sound of a microwave oven working.

If the user entered the correct cooking time the microwave will “ping” when the time is complete, the user may open the door of the microwave oven and the audible content will play the sound of cheering while the screen 30 displays the word “Congratulations” (Step 51).

However, if too great a cooking time is entered, the visual content will indicate that the food is burning by making the inside of the microwave oven appear dirty (Step 52). The user may then drag their finger across the screen to clean the microwave oven (Step 53).

In either case, the user will then be given the option to continue playing or to change the appliance to a different piece of kitchen equipment (Step 54).

It will readily be understood that the description hereinabove with reference to FIG. 27 merely describes one example of novel play made possible by the teachings of the present disclosure. It is Applicant's intention to encompass electronic applications relating to play use of any other kind of kitchen appliance. Once the steps required for play use of a particular kitchen appliance, such as the exemplary microwave of FIG. 27, have been established by a simple flow diagram such as that of FIG. 27, the coding required to translate that flow diagram into a fully working electronic application for a tablet computer or smart phone will be a mere matter of routine fully within the capability of a person of ordinary skills in the electronic applications coding field, so that no further description is deemed necessary.

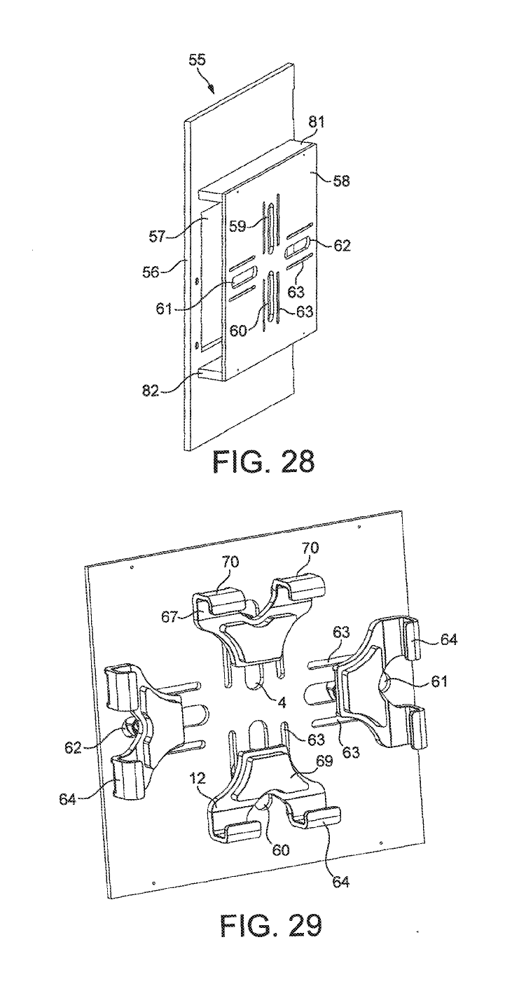

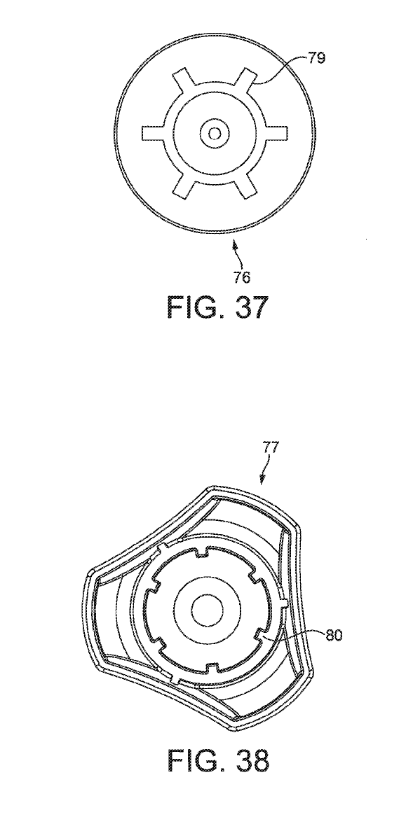

Turning now to FIGS. 28 to 38, which illustrate improved means for holding an electronic device behind a front panel of a representation of a piece of kitchen equipment. As will become apparent from the detailed description below, these figures show systems capable of holding the electronic device more securely, and allowing for more readily adjusting the position of the device relative to an opening in the front panel. Some employ so-called “childproof” knobs that require to be pushed and turned simultaneously.

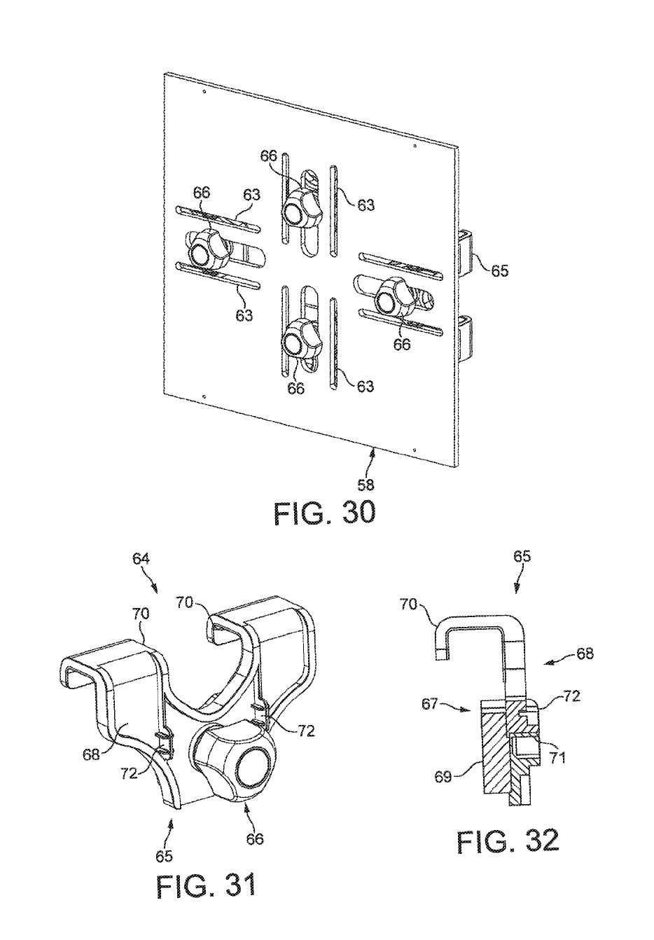

As shown in FIG. 28, a door 55 which forms part of a children's play kitchen comprises a front panel 56 with an aperture 57 therethrough. Located behind the front panel 56 is a rear panel 58, the rear panel 58 containing two vertically aligned slots 59, 60 and two horizontally aligned slots 61, 62, the slots being arranged in a cruciform arrangement. Each slot 59-62 has a pair of guide slots 63, one running parallel thereto on either side of the slot, for a purpose to be explained below. As shown in FIG. 29 and FIG. 30, clamps 64, each comprising a bracket 65 and a knob 66, a shank of which is received in the bracket as explained below, may be fastened through slots 59-62. When the user wishes to move the clamps 64, the knobs 66 are loosened sufficiently for the clamps 64 to be slid up and down in slots 59 and 60 or left and right in slots 61 and 62.

In the arrangement of FIGS. 28 to 30, a piece of electronic equipment such as a tablet computer or smart phone may be inserted into the space between front panel 56 and rear panel 58 either by removing one of the clamps 64 in horizontal slots 61 and 62 and replacing it once the electronic equipment is in the desired position or alternatively by adjusting the position of any or all of clamps 64, inserting the device through the front aperture 57 and then readjusting the position of clamps 64 before tightening the knobs to securely hold the electronic device in place.

As shown in FIGS. 4 and 5, each bracket 65 has a front side 67 and a back side 68. The front side 67 makes contact with the electronic equipment via padding 69 attached to the front side. Each bracket 65 has a bifurcated hook 70 which is adapted to pass around the edge of the electronic device to hold it in place. The back side 68 includes a threaded metal insert 71 embedded therein, and adapted to receive the shank of a corresponding knob. The back side 68 of the bracket 65 also includes two protrusions 72 designed to be received in the guide slots 63 in rear panel 58. The combination of the shank of the knob in the main slot and protrusions 72 in guide slots 63 ensures that the bracket 65 maintains the desired orientation as it is slid along the main slot. It will readily be appreciated that the guide slots 63 may be replaced by grooves in which protrusions 72 are received.

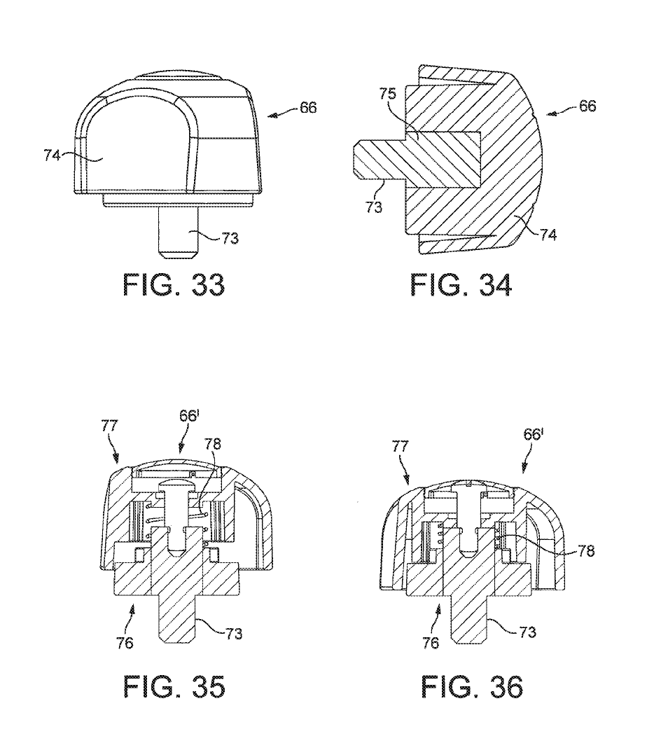

Referring now to FIGS. 33 and 34, each knob 66 is provided with a threaded shank 73 The knob comprises a solid head 74, into which is inserted a shank section 75 bearing the threaded shank 73. The threaded shank 73 is capable of screwing into the correspondingly threaded metal insert 71 in the back side 68 of the bracket 65.

In an alternative embodiment, shown in FIGS. 35 to FIG. 38, the knobs 66′ are adapted to operate in a so-called “childproof” function. In this embodiment the knob 66′ comprises inner 76 and outer 77 sections. In order to screw or unscrew the knob the inner 76 and outer 77 sections must be engaged with each other. To prevent young children playing with the knobs from readily removing the electronic device from the play kitchen, inner section 76 and outer section 77 are biased apart from each other by a spring 78. To engage the inner 76 and outer 77 sections, the spring 78 must be compressed. The spring 78 used is of a suitable stiffness such that an adult can easily compress it, but a young child would have difficulty in doing so. Once the spring is compressed, teeth 79 on the knob inner 76 are engaged with notches 80 on the knob outer 77, and the knob 66 may be tightened or loosened as required. It will readily be appreciated that the teeth and notches may be reversed. Arrangements that require simultaneous pushing and turning to operate are commonly referred to as “childproof” locks.

The brackets 65 and knobs 66 could be made from a variety of materials. However, Applicant has had success making the knobs 66 from injected plastics and the brackets 65 from injected plastics with the padding 69 comprising a foam block.

It should also be noted that, although in FIG. 28 the rear panel 58 is shown connected to the door 1 by a top wall 81 and bottom wall 82, the rear panel 58 may instead be connected to the door 1 by any combination of top, bottom, left and right connecting walls. It will also be appreciated that, whereas an arrangement with four clamps will give goods results, in some circumstances, such as where a lower edge of the electronic device sits on bottom wall 82, just two or three clamps may suffice.

1. A children's play kitchen, the play kitchen including a representation of a piece of kitchen equipment, the representation including a front panel provided with a holder, the holder being adapted to hold a piece of electronic equipment selected from tablet computers, smart phones and other programmable devices having a generally flat screen on a front side thereof, the piece of electronic equipment containing preloaded software such that when a user activates the software the screen displays visual content making it appear as if the kitchen equipment were in use.

2. A children's play kitchen according to claim 1, wherein the front panel is provided with an aperture and the holder is provided behind the front panel, such that when the piece of electronic equipment is held in the holder the screen is visible through the aperture.

3. A children's play kitchen according to either claim 1, wherein the holder includes a fixed platform and at least one movable clamp adapted to operate in conjunction with the fixed platform.

4. A children's play kitchen according to claim 1, wherein the holder includes at least two clamps designed to hold the electronic equipment between them.

5. A children's play kitchen according to claim 3, wherein the holder includes two clamps designed to hold the electronic equipment between them, and each including an element adapted to engage an edge of the piece of electronic equipment, the said element including two surfaces orthogonal to each other, one said surface being adapted to engage a vertical edge of a said piece of electronic equipment to hold it vertically with its screen facing forwardly of the kitchen equipment, and the other said surface being adapted to prevent the said piece of electronic equipment from falling forwardly from a vertical position.

6. A children's play kitchen according to claim 4, wherein a rear panel is positioned behind the front panel, the rear panel mounting said at least two clamps, the said clamps being slidable along at least one slot and each being fixable in position along the or a said slot, each clamp comprising a bracket and a shank extending through the associated slot and mounting a tightening knob, whereby the separation between the respective brackets may be adjusted to hold a said piece of electronic equipment between them with each bracket engaging a respective edge of the electronic equipment, each bracket having a hooked portion adapted to hook around an edge of the electronic equipment on to a front surface thereof, whereby tightening of the knob draws the hooked portion of the bracket into engagement with the said front surface to hold the electronic equipment against the said rear panel.

7. A children's play kitchen according to claim 4, wherein each bracket has at least two protrusions on its rear face, and each slot is associated with two guide slots or grooves in the rear panel running parallel to and on either side of the slot and adapted to receive the protrusions to assist in maintaining a bracket in a desired orientation during movement and when held in position by tightening the knob.

8. A children's play kitchen according to claim 3, wherein the position of the or each clamp may be selected by a user; and wherein the or each said clamp includes at least one tightening knob adapted when tightened to hold the clamp in position.

9. A children's play kitchen according to claim 6, wherein the or each knob comprises two sections, namely an outer section and an inner, biased apart by a spring, the inner section being provided with a series of one of teeth and notches designed to interfit with a corresponding series of the other of notches and teeth provided on the outer section, so that the knob may be tightened or loosened only when the inner and outer sections are engaged to interfit teeth and notches by a user against the bias of the spring.

10. A children's play kitchen according to claim 9, wherein the inner and outer sections are adapted to engage by compressing the spring, the stiffness of the spring being selected so that an adult can readily compress the spring, but young children would find this more difficult, thereby deterring a child from removing the electronic device from the holder by playing with the knobs, since loosening a said knob to allow removal would require the knob to be pushed and turned simultaneously.

11. A children's play kitchen according to claim 1, wherein the holder comprises a pocket into which the piece of electronic equipment may be inserted from above.

12. A children's play kitchen according to claim 1, wherein the holder is associated with at least one clamp adapted to hold the piece of electronic equipment against a front surface of the front panel, and wherein the or each said clamp is hidden behind a decorative element.

13. A children's play kitchen according to claim 1, wherein the piece of kitchen equipment is selected from an oven, a microwave, a washing machine, a tumble drier, a coffee machine, a blender, a mixer and a fridge-freezer.

14. A children's play kitchen according to claim 1, wherein at least one speaker is associated with the said piece of electronic equipment so that when the visual content is displayed on the screen of the electronic equipment corresponding audible content accompanies the visual content.

15. A children's play kitchen according to claim 1, wherein the software is interactive such that the content varies depending on options selected by a user.

16. A combination of a children's play kitchen and an electronic application for a tablet computer or smart phone; the play kitchen including a representation of a piece of kitchen equipment, the representation including a front panel provided with a holder, the holder being adapted to hold a piece of electronic equipment selected from tablet computers and smart phones;
and the electronic application being programmed to display visual content on the screen of the electronic equipment making it appear as if the kitchen equipment were in use.
